(19) United States
(12) Patent Application Publication
(10) Pub. No.: US 2008/0301571 A1
(43) Pub. Date: Dec. 4, 2008

(54) System and Method for Administration and Documentation of Health Care Services

(76) Inventor: Robert M. Herzog, New York, NY (US)

Correspondence Address: M. Scott Carey, 257 E. 7th Street, Apt 10, New York, NY, 10009, US

(21) Appl. No.: 12/016,864

(22) Filed: Jan. 18, 2008

Related U.S. Application Data
(60) Provisional application No. 60/885,408, filed on Jan. 18, 2007.

(51) Int. Cl. G06F 3/048

(52) U.S. Cl. 715/764

(57) ABSTRACT

A method and system for collecting data that employs selectable pictographs, as presented via an interface, that a user can select and populate a data field by correlating what is observed or what actions are taken with the available selectable pictographs. Once the selectable pictographs are selected and the relevant data field populated the information contained in the pictograph is stored in a computer readable medium and/or database. The method and system of the present invention as applied to the health care field provides for increased efficiencies to those providing health services and aids in lowering health care costs.

### PRIORITY

This application claims the benefit of earlier filed U.S. Provisional Application No. 60/885,408 filed on Jan. 18, 2007 and is incorporated herein by reference in its entirety.

### FIELD OF INVENTION

The present invention relates generally to systems and methods for data collection, data display, data processing, and data preservation and, more particularly, but not exclusively to the collection, display, processing and preservation of data collected on an individual under a course of care and/or treatment employing a novel pictograph language and system for logging collected data about an individual.

### BACKGROUND

Health care costs in the United States continue to increase and grow at annual rates that outstrip annual cost of living adjustments. It is currently estimated that health care costs consume sixteen (16%) of the economic output of the United States.

A number of factors contribute to high health care costs and include, without limitation, (i) regulatory compliance, (ii) insurance compliance, (iii) health records administration, (iv) the cost of care delivery, and (v) the location where care is provided. Systems and methods are needed to better control the costs associated with health care costs.

In addition to controlling significant health care costs, patients desire humane and comfortable and familiar environments in which to convalesce, such as for example, their own home, the home of a family member, hospice, or other non-hospital surroundings if given the option. Such non-hospital facilities have been shown to both increase the quality and decrease the cost of overall health care provision, and are increasingly supported by health care policies.

The invention as presently disclosed provides for the cost efficient collection, transmission and management of patient data and records management, a flexible system that permits the administration of care to a patient that is location non-specific, greater transparency into a patient's current state of health by the patient's health care providers and/or health care decision makers, and more patient information than can be typically obtained through clinic and/or doctor office visits which is configurable to show information at varying degrees of granularity and in various graphical formats.

### Data Collection and Health Record(s) Administration

Among the significant factors that contribute to the cost of providing health care services are the extensive federal, state, local law and regulations and accreditation agencies' requirements relating to thoroughly documenting virtually each and every intervention relating to care and treatment of the patient. The patient's health records and in turn the patient's financial records, as they relates to their care, must be created, maintained and preserved by all providers ministering to the patient with sufficient detail reflecting the precise nature of the care provided and/or treatment and other relevant information.

The health records created and maintained by all health providers are at the core of the health care system. All relevant and authorized parties responsible for the care, treatment and payment for the care rely on these records and/or information for a myriad of reasons, including but not limited to the needs to: (a) monitor the care and treatment of patients; (b) modify treatment plans to reflect the physical changes mandated by the patient's condition; (c) hold health care providers accountable for their decisions, intervention and outcomes; (d) audit the adequacy, consistency, quality and/or thoroughness of the care provided; (e) formulate, route and/or audit invoices for health care services provided; (f) evaluate the qualitative performance and productivity of employees and independent third parties involved in the health care of a patient; and/or (g) determine compensation of health care providers; (h) demonstrate and/or audit compliance with the patient's treatment plan.

To date, the medical record(s) has been largely maintained in handwritten form (i.e., paper) with entries made in the medical record by physicians and nurses and through the compilation of various forms (i.e., lab test, ancillary reports) submitted by various other providers. Further, the records are typically stored in disparate locations and document retrieval systems and databases that are proprietary and/or that cannot exchange, query and/or link information due to different system architectures and/or other software and/or hardware incompatibilities.

Given the extensive need for thorough and complete documentation coupled with the need for accessibility to the data by a variety of professional caregivers who have responsibility for some aspect of the medical, psychological, social services, pharmaceutical, diagnostic testing of the patient's needs, a need exists for the efficient collection of patient health information and the availability of same to all the relevant parties in the health care hierarchy in a transparent manner.

Central to maintaining any medical records, electronic or paper, is the timely entry of a well articulated, legible, accurate description of the patient's condition currently and throughout the course of treatment, enabling all participating providers to assess the progress, or lack thereof, of the patient.

The present invention set forth herein provides a unique system and method to assist providers, at all levels, to quickly and accurately memorialize the patient's condition and any positive or negative changes. The present invention employs a novel icon/pictograph language to gather patient information and provide and/or adjust courses of treatment.

The present invention provides a unique means to reduce the amount of time and related costs and inefficiencies health care providers spend on medical and social records documentation, which is necessary to comply with Federal and State legal and regulatory requirement, professional and institutional accreditation agency requirements and governmental and private health insurance requirement for billing and collections, as well as meet the standards for “pay for performance” reimbursement, thus increasing the productivity of such professionals in providing their critical duties. Utilizing the present invention, physicians, nurses and technicians can enter into the medical record the medical histories, diagnoses, physician orders, nursing notes, enter test results and document and monitor the treatment plans and therapies associated with specific diagnostic related groups (DRGS) and their related (CPT) codes, as well as develop, monitor and modify associated plans of care.

In one embodiment of the present invention, the icon/pictograph language of the present invention is directly correlated to the patient's diagnosis and treatment plan organized by the diagnostic related group, Current Procedural Terminology (“CPT”) code and/or other generally accepted medical lexicons. Selection of relevant icons/pictographs allows a user to readily document and/or record a patient's condition, both current and historical. The documented condition, via the particular selection of icons/pictographs, is memorialized in an electronic medical record, which can then be printed or otherwise made into a hard copy for further processing, such as insertion into a patient's physical health file, or viewed electronically. A significant savings of time and effort is realized through the use of the present invention.

The present invention permits physicians, nurses, physical therapists and other professionals and health care providers an increase in productivity for providing care to the patient and in reporting on and documenting the patient's condition, compliance with physician orders and/or approved treatment plans. In addition, the patient's information can be readily retrievable, aggregated for specific time frames and examined to observe trends, which permits, for example, the determination whether the patient's plan of treatment should be modified. Additionally, once collected, the data can be readily integrated with other medical classification, procedural or diagnostic codes and databases.

As a further feature, the invention provides accurate record-keeping, monitoring, and documentation of work effort and a time record for payroll purposes of all personnel assigned specific elements in the care and treatment of the patient.

### Care Administration and Location of Care

The health care system in the U.S. and throughout the world operates on a highly specific tiered system of providers offering the full spectrum of health care services to patients including personal physician services, acute and specialty hospital services, ambulatory care services in general and specialty outpatient clinics, diagnostic and treatment centers, nursing homes, assisted living facilities and home care services.

Among the array of health care providers, the home care and assisted living providers are the least developed in the use of electronic records and electronic monitoring of their patient care services. In addition they rely heavily on unskilled and/or semi-skilled non-professional workers to minister to patients in accordance with physician and/or nurse ordered treatment plans. Many of these workers are newly arrived immigrants with limited or no English speaking proficiencies. The present invention alleviates many of the language barrier limitations of these workers who are charged with caring for the patients as well as offers their employers and/or the responsible individual(s) for the prescribed course of care real time monitoring of the care without having to be on-site.

The present invention also allows for the cost effective collection and communication of patient's home care information to all relevant health care professionals who contribute to patient care and treatment whatever the facility.

The present invention further allows greater transparency for the patient, the patient's family and the health care professional with respect to the nature and quality of the care provided and the patient's condition.

Moreover, the present invention provides for scheduling and “ticklers” reminding health care providers or patients to administer a course of care, for example, consume a dosage of medication, and/or perform an action.

Further, the present invention enables a patient to administer their own care program from the familiar surroundings of their own home and amongst their own family members by following a prescribed treatment and updating certain observables to the system via the icon/pictograph language. The present invention thus allows a physician or other health care provider to adjust the prescribed treatment remotely and at a granularity defined by the physician or other health care provider and not limited to in personal examination at the health care provider's office before doing so.

These and other objects and advantages of the present invention will become more apparent after consideration of the ensuing description and the accompanying drawings.

### SUMMARY

The present invention provides a method and system that employs pictograms, pictographs and/or icons (hereafter collectively “pictographs” and having the meaning of a pictorial or graphic representation of a place, state, action, noun, or any other any concept, idea, or thing (tangible or otherwise) that can be represented symbolically as a pictorial or graphic representation) to record information about an individual. The method and system present a user with pictographs. The user selects applicable pictographs to populate at least one data field. Additional embodiments consistent with the present invention present a user with a pictograph or series of pictographs that instruct a user to take an action as a result of the information contained in the pictograph.

The pictographs of the present invention are customizable and may be configured in any number of groupings and/or sets, as dictated by the health care provider and/or needs of the patient so as to provider for a more customizable treatment plan and allow for the efficient selection of pictographs.

A further embodiment consistent with the present invention translates pictographs entered in various data fields into various readout forms, data sets and document formats. The populated data fields may then be accessed remotely and/or through a system on-site, allowing for periodic review. Passwords or other security methods may be established to protect patient privacy and to ensure only those health care providers responsible directly for patient care can access the collected data.

The present invention is compatible with and may be used with a myriad of electronic devices including, but not limited to, network devices, PDAs, internet tablets, touch screen devices, wireless devices, and mobile devices.

Application of the present invention include, but are not limited to: (1) entering and monitoring the performance of plans of care (a set of treatments and activities as proscribed by a care professional), treatments and other services; (2) trend spotting; (3) developing a database(s) on a population segment(s) or other group(s); (4) recording, tracking, monitoring, and evaluating vital signs and displaying the information in various formats, processed and unprocessed, to the relevant parties whether on-site or remote; (5) tracking specific medications administered, interconnecting with physicians, pharmacists, administering entities, insurance companies and other relevant parties through an application screen allowing for exception reports and the administration of both regular medications and PRNs and notes; (6) creating electronic plans of care; (7) aiding in meeting regulatory and institutional requirements for audits, quality control, documentation, and fraud and abuse control; (8) tracking treatments and other services; (9) providing substantive supplement to a medial record; (10) documenting conformity with a plan of care; (11) tracking hours of service and providing billing services; (12) identifying additional care services needed; (13) tracking actual care provided; (14) providing current and historical patient data to relevant parties; (15) sharing data among relevant parties; and (16) tracking bill payments.

The present invention improves care quality by providing, for example, (1) up to date monitoring, evaluation of care services and plan of care; (2) cues to aides, patients and other health care providers to perform and/or stop performing a specified action and/or activity; (3) data sets that allow changes in conditions to be observed and recorded; (4) data for the creation of database(s), normative comparisons, treatment evaluations, and other analyses; (5) longer patient home stays, i.e., shorter hospital stays; (6) ready access to care information for all care providing parties; (7) support for regulatory compliance, audits and Quality Assurance/Quality Control (“QA/QC”) requirement; (8) improved tracking and accountability; (9) uniform data entry and reporting formats; (10) better care; and (11) a decrease in administrative overhead.

The present invention provides a method and system for collecting data that employs selectable pictographs, as presented via an interface, that a user can select and in turn use to populate a data field by correlating what is observed or what actions are taken with the selectable pictographs. Once the selectable pictographs are chosen and the relevant data field selected the information contained in the pictograph is stored in a computer readable medium and/or database.

An embodiment consistent with the present invention employs a palette for receiving pictographs. The palette is associated with a particular data field. Data fields typically represent a predefined time interval, but are not limited to such representation.

Another embodiment is the direct entry of pictographs into a graphic or other representation of time and/or location fields, by dragging the pictograph, selecting it on a touch screen or other form of selection and entry, with such information being stored in computer readable medium and/or data base.

Another embodiment consistent with the present invention allows users to associate a particular pictograph with a particular data field by dragging and dropping the pictograph to the palette or other representation associated with the data field, or by otherwise selecting the pictograph using a touch screen or similar device for data entry.

A further embodiment consistent with the present invention assigns a color to each pictograph. The color assigned to each pictograph is based on what class or group a pictograph belongs to. For example, pictographs associated with an individual's moods may be yellow and with food consumption blue. The particular color assignment for each class or group is not important in itself, but having different colors assigned to each class or group allows for the easy differentiation at a glance of the data collected.

An additional embodiment consistent with the present invention assigns a user identification code to each pictograph selected by the user and dragged to the palette or data field, wherein each user identification code is unique to the user. This embodiment allows for the calculation of the dollar amount to pay each user based on the data fields populated.

An embodiment consistent with the present invention updates the database, and thus the particular data field, with the information represented by the selectable pictograph only if the selectable pictograph is compatible with the data field and/or other selectable pictographs selected for entry into the data field.

A further embodiment consistent with the present invention displays a course of medical care through a set of selectable pictographs.

An additional embodiment consistent with the present invention revises the set of selectable pictographs as a result of the data collected.

An embodiment consistent with the present invention provides a selectable pictograph representing a concept, object, activity, place, event, task, state of being, condition, task, medical information, report data, environmental conditions, function, body task, schedule, observed health states, observed conditions of an individual, observed states of an individual, observed characteristics of an individual, or any combination thereof.

An embodiment consistent with the present invention compares the collected information to update a database against one of a plan of care, insurance requirements, physician instructions, nurse instructions, compliance rules and regulations or combinations thereof.

An additional embodiment consistent with the present invention wherein pictograph instructions are sent to a user that instructs the user to perform a particular task.

A further embodiment consistent with the present invention wherein a system for recording information is provided that includes a client computing device, a server computing device, a network link between the client computing device and the server computing device; a graphical user interface operable on the client computing device; a catalog of selectable pictographs generated by the server computing device and displayable in the graphical user interface; a collection of data fields generated by the server computing device and displayable in the graphical user interface; a processor that is operable to perform actions, including, assigning selectable pictographs selected from the catalog of selectable pictographs to at least one data field and directing the storage of the information contained in each selected selectable pictograph to a computer readable medium.

Another embodiment of the system includes translating the pictographs after they are used to enter information into a database, converting them into various possible forms of readouts, text, graphics, and reports, which can be accessed by all relevant parties through networks and the Internet, and configured in various ways for users to view, utilize, understand and interpret them, with multiple options for periodic review. Such readouts may also be used to meet administrative, regulatory and institutional requirements for documentation.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a network device that may be included in a system implementing the invention;

FIG. 4 is an annotated schematic representation of a logger window in accordance with the present invention;

FIG. 5 shows one embodiment of a use case illustrating a journal section for a single day in accordance with the present invention;

FIG. 6 shows one embodiment of a use case illustrating a journal for a single week in detail in accordance with the present invention;

FIG. 7 shows one embodiment of a use case illustrating a journal illustrating a single week in accordance with the present invention;

FIG. 8 shows one embodiment of a use case illustrating journal illustrating a single month in accordance with the present invention;

FIG. 9 shows one embodiment of a use case illustrating payroll calculations in accordance with the present invention;

FIG. 10 shows one embodiment of a use case illustrating caregiver hours worked and wages due for a single week in accordance with the present invention; and

FIG. 11 shows one embodiment of a use case illustrating caregiver hours worked and wages due for a single year in accordance with the present invention.

### DETAILED DESCRIPTION

The present invention may be further understood with reference to the following description of exemplary embodiments and the related appended drawings, wherein like elements are provided with the same reference numerals, and which form a part hereof, and which show, by way of illustration, specific exemplary embodiments by which the invention may be practiced. This invention may, however, be embodied in many different forms and should not be construed as limited to the embodiments set forth herein; rather these embodiments are provided so that this disclosure will be thorough and complete, and will full convey the scope of the invention to those skilled in the art. Among other things, the present invention may be embodied as methods or devices. Accordingly, the present invention may take the form of an entirely hardware embodiment, an entirely software embodiment or an embodiment combining software and hardware. The detailed description is, therefore not be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The present invention provides a method and system that employs pictograms, pictographs and/or icons (hereafter collectively “pictographs” and having the meaning of a pictorial or graphic representation of a place, state, action, noun, or any other any concept, idea, or thing (tangible or otherwise) that can be represented symbolically as a pictorial or graphic representation) to record information about an individual. The method and system present a user with pictographs. The user selects applicable pictographs to populate at least one data field.

The pictograph language of the present invention provides a system and method for administering, managing, and monitoring care to a patient and/or a population of patients and/or care receivers; collecting information on health states of a patient or group of patients; and collecting data, administering, managing, and storing health records of all types. For example, under one embodiment of the present invention pictographs are selected from listings, libraries, and/or catalogs of pictographs and recorded in a database and/or databases by a caregiver or the individual himself that correlate with patient observables and/or caregiver actions and/or required actions by caregivers.

An exemplary system allows and/or prompts a caregiver to make pictograph selections for predefined time intervals and dates, such that the condition of the patient and/or the care giver actions are recorded for when the condition existed and/or the action occurred and to within the predefined time interval. Thus, the present invention provides a user of an exemplary system of the present invention with the tools to administer a treatment program outlined by a primary care professional as well as communicate a patient's condition to the patient's primary care professional and all other parties of interest across various time windows and metrics.

For example, the present invention may be implemented in the following environment. An individual stricken with a stroke is released, once stable, from hospital care to a home care situation. The primary care physician prescribes a 24 hour, 7 days a week program for care at home that includes, for example, the administration of medications at prescribed intervals and physical therapy as well as monitoring patient conditions and activities of daily living (ADLs) at regular intervals. Typically, care for the individual at home is carried out in shifts and/or across several persons. This may consist of a professional home care staff, family members, and/or a combination thereof. The present invention provides a system and interface for collecting data on the individual based on the prescribed care program and can include signaling cues to the user for administering medications/treatments/actions to the individual and/or recording information. The recordation of information and cueing of the user is done through the use of a pictographic language. When recording the condition of the individual at a predefined time metric the information is captured by identifying pictographs that correspond to the observed condition and/or data collected. The selected pictographs are used to populate a database and/or databases and/or time fields. For example, if the individual under care is observed reading between 11 a.m. and 12 p.m. the caregiver would select the pictograph representing this activity. The pictograph is recorded in a database and/or time field in a manner such that the information can be retrieved and reviewed as the field is populated and/or at a later time. Additionally, performance of a cued activity may be recorded by selected the corresponding pictograph and populating the respected field with the pictograph(s). The collected information may then be accessed by the various caregivers responsible for the individual and/or the individual's loved ones and/or institutions interested in the care of the individual for reasons of, for example, compliance, regulatory and/or quality assurance, and third party payment for services. Use of the present invention eliminates information gaps that occur due to different number of caregivers. Additionally, access to the collected information allows loved ones to observe the quality of care the individual is receiving. Further, the primary physician can quickly observe trends and change the course of treatment if necessary. The course of treatment can be altered by simply making available to the end user a new set and/or augmented set of pictographs and/or new cues. Moreover, institutions can quickly review the course of care to insure it meets certain standards and/or requirements so that, for example, insurance payment processing can occur more quickly.

According to exemplary embodiments, the present invention may be operable within a variety of network architectures and/or network architecture combinations. The term network may apply to all currently existing and future developed architectures. These network architectures may include local area networks (“LANs”), either wired or wireless. Exemplary LANs include peer-to-peer (“P2P”) networks, virtual private networks (“VPNs”), and client-server networks. Alternatively, the network architectures may include wide area networks (“WAN s”), either wired or wireless. Regardless of the type of network architecture, or combination of architectures, used for the exemplary embodiments of the present invention, the collected information through use of pictographs may be made available to viewers over a network. For example, the collected information may be accessible through the Internet, World Wide Web, or other networked device, such as a mobile phone, PDA, or web device. Additionally, the collected information my be recorded and/or collected through, for example, the use of a networked device, mobile phone, PDA, and/or web device, internet tablet, and/or touch screen device.

According to the exemplary embodiments of the present invention, a user interface is presented to a caregiver. The system user interface presents the user with a listing, catalog, and/or library (hereafter “library”) of pictographs, from which all or some of the pictographs may be employed. The pictographs are user selectable. The application and particular course of care will determine how many of the pictographs are selectable. By selectable it is meant that the pictographs can be clicked and dragged using a mouse, selected via a combination of keystrokes, selected using the input mechanism of a mobile device, such as for example, a pen stylist, finger tip, jog dial; and/or otherwise identified and singled out from other pictographs such that the information contained in the selected pictograph can be recorded. The user selects the relevant pictographs and populates a predetermined subspace of the interface. The pictographs are selected based on patient observables and/or care giver actions. For example, a caregiver administering a plan of care may observe that the patient was reading during the interval of 1 p.m. to 2 p.m. on a particular day. The caregiver would select the relevant pictograph, in this case a picture of a book, that corresponds to the observed condition and populate the predetermined subspace of the interface. More than one pictograph may be selected for any single interval. Additional examples of pictographs in accordance with the exemplary embodiments of the present invention are legion and include any patient observable, environmental observables, and any caregiver action. Additionally, the present invention includes the ability to record physical condition, such as range of motion, and enter numerically or graphically and to differentiate between activities done independently and those that required assistance (assisted versus unassisted). Once all the relevant pictographs for the predefined interval are selected and populated in the subspace of the interface, the pictographs are recorded for the predefined interval. Once recorded the pictograph entries can be recalled, searched, and/or further processed—either individually or with other intervals and entries—to produce aggregate state, status, condition information and/or reports.

The present invention employs an icon and/or pictographic based language for easy, non-text based communications of extensive data, for health care, social care, and general data base entry. The language may be used in conjunction with Web based management, monitoring and review. Moreover, the pictographs are translatable into various forms of readouts with remote Web access. Further, the translation of the pictographs permits assessment of services and conditions, trend spotting, and the development of a large data base containing unique information on how large population segments behave and spend their time, for normative, comparative and assessment purposes.

According to an exemplary embodiment of the present embodiment, the system user interface for recording observables and/or caregiver actions is divided into three main regions. The regions include (i) a pictograph library; (ii) a palette for receiving selected pictographs; and (iii) a logger which can be divided into time intervals or other segments.

The pictograph library may be set up so that all available pictographs are shown at once or pictographs may be stored under subject matter headings and/or descriptors. For example, headings may be divided into different domains and associated with a domain according to some predetermined scheme, whereby selecting a heading reveals the pictographs relevant to the heading. For example, if only two domains exist they may be caregiver actions and patient observables. Alternatively, the number of headings could be greater than two and need not be divided by caregiver action versus patient observables. The only requirement of the pictograph library is that it has and/or is capable of receiving pictographs and that the pictographs be selectable. Additionally, each pictograph may be associated with a unique color and/or color from a color classification scheme. For example, each pictograph may be linked and/or associated with a color, wherein each available color is part of a classification scheme. For example, each pictograph may be associated with at least one of the color yellow, blue, violet, red, green, orange, and indigo. Each of these colors in turn may be associated with a particular state or activity, for example, one of awake, sleeping, being outside, activities, meals, medical tasks, states of mind and body tasks, among others.

Pictographs also have help text feedback associated with them—that is, when you select or rollover the pictograph, text associated with it may appear on other portions of the screen. Pictographs could also have sound associated with them as well as text.

The palette for receiving pictographs represents a predefined area of the interface for receiving, temporarily storing, editing and/or recording pictographs. The palette can assume any shape and size. The palette may further include scroll bars for moving horizontally and/or vertically within the palette. Pictographs may otherwise be moved or noted in order to enter them in the database, including but not limited to selecting them on a touch screen device whereby such selection automatically enters the information associated with the selected pictograph into a computer recordable medium and/or data base.

The logger represents a predefined time interval and calendar date. The granularity of the logger may be selectable and/or tunable. For example, the logger may be configured to represent a related set of time interval windows. The granularity of the time interval windows may be varied. As an example the time interval windows may include cells representing half hour time intervals. According to an exemplary embodiment of the present invention, a field in the logger is selected. For example, each field in the logger represents a half hour time interval. Once a logger field is selected it becomes associated with the palette. This association may be a direct and visible association or an indirect association where the selected logger field remains highlighted during the population of the palette with pictographs. While the selected logger field is being populated via the palette with the information contained in the pictographs, other non-selected logger fields may provide indications of whether they have been populated and if so with details and/or summaries of what populated them. Once all the relevant pictographs for the selected logger field have been selected and placed in the palette they are recorded and stored so that the collected information can be retrieved and/or further processed at a subsequent time. For example, the information may be stored on a computer system local to the user and/or on an external server that is remote from the user.

According to an exemplary embodiment of the present invention, information collected regarding patient observables and/or care giver actions using pictographs is stored and/or retrievable in a journal format, i.e., a ledger, daybook, transaction log wherein each calendar day is divided into predefined time intervals. The journal is selectable and configurable such that a single entry, a single day, a single week, a collection of weeks, a single month, a collection of months, a single year and/or a collection of years, and their associated information, are viewable. The information displayed at whatever selected granularity of detail can be pictographs, words, phrases, and/or colors. For example, the time intervals for a week or month may contain the color or colors associated with the actual patient observables and/or caregiver actions for that period. The color or colors displayed may be user selectable.

According to a further exemplary embodiment of the present invention, the system and method allows the calculation of payroll for caregivers. Every time interval that receives a pictograph may also receive the identification, either as a pictograph and/or log in codes and/or other identification information, of the caregiver entering the collected information. For example, if the time intervals are each 1 hour in length the system and method of the present invention will calculate the number of 1 hour intervals (or portions thereof) associated with the care giver for a given day, week and/or month. Once the number of I-hour intervals has been computed, that number is then multiplied by the caregiver's hourly wage (or if salaried, compared against hourly minimum requirements) to determine the caregiver's paycheck. Additional granularity of time is also available and the present invention is not limited to 1 hour time increments. Moreover, the present invention allows for additional verification that the caregiver collecting the information actually collected the information by including interoperability with a GPS system and/or device, bar code reader or other identification system thereby not only recording the information collected by the caregiver through the use of the pictographic language of the present invention but also positional and/or geographical information.

According to another exemplary embodiment of the present invention, a primary care professional may revise a plan of care by providing the caregiver a revised pictograph library. For example, after a week's collection and recordation of patient information the primary care professional might observe a trend by review of a weekly journal. Based on the weekly journal the primary care professional may determine that additional or alternative treatments or records are needed. The primary care professional, via the system and method of the present invention, may then revise, based on the additional treatments or records, the catalog of pictographs available to the care giver. The list of available pictographs may be limited to keep the caregiver focused on particular treatment and/or record keeping objectives.

According to an exemplary embodiment of the present invention, a fourth region is present on the user interface with the pictograph catalog, palette, and logger. This region represents pictographs of actions the caregiver must take in a particular time interval. For example, if the patient must have his or her teeth brushed every 8 hours the fourth region would present a toothbrush pictograph or other relevant pictographs every eighth hour. To insure that the caregiver carried out the activity, the pictographs in this fourth region would be selectable so that they could be added to the palette once the actions were performed. Every pictograph that may appear in the pictograph library may also appear in this fourth region. This system may also be used in conjunction with the timely administration of medications.

The present system and method can be implemented in Adobe's Flash®, but is not limited to Adobe's Flash® programming language presently known or developed in the future.

According to further application consistent with exemplary embodiments of the present invention, the system and method of the present invention may be developed around meeting regulatory and/or compliance requirements; populating various patient forms for regulatory, institutions—such as insurance, treatment, and/or medical history such as Medicaid and Medicare forms; and generating graphics, bar graphs, and/or charts for patient analysis and/or trend observation. The applications and uses of the data, once collected through use of the present invention, are legion and include all methods of processing data currently known or subsequently developed. Moreover, the collected data can be output into existing systems, such as payroll systems.

Additionally, the present invention can cue the system user to take affirmative actions such as take patient vital signs, including pulse, blood sugar level, temperature, weight and respiration, and the ability to enter the vital signs either numerically or graphically. Further system cueing includes cues for doctor's appointments, recreational activities, etc. Additionally, the present invention allows for the expression of personal preferences for the care recipient, such as menus, dress, habits, likes and dislikes.

Additionally, the present invention supports Instant Messengering or other communications system between the aides and care managers/professionals/family members. Further, the present invention may be interfaced and/or in communication with existing information systems, such as the ICD-9 Diagnostic menus, or databases regarding drug interactions. Moreover, the present invention may employ a video capture system such as a Web cam or other video capture device and be used for picture or video viewing and teleconferencing.

Additional features and attributes of the present invention and overlapping embodiments include: customization of pictographs and/or classes of pictographs; replication of a plan of care in which a select number of activities—eating, bathing, brushing teeth etc.—are selected by an agency or other organization to be represented in the selectable pictographs, and a home aide is directed to perform only those activities; pictographs that differentiate between doing something with assistance or not; providing reports on patterns of behavior, trends, variances and exceptions, other analyses; recording and tracking of vital signs, including pulse, blood pressure, respiration, blood sugar, weight, temperature, etc.; tracking of ADLs—“Activities of Daily Living,” which are a primary industry method for checking status, developing rehab plans and monitoring capability.

Input devices and methods include, but are not limited to, mobile devices, cell phones or comparables systems, variations on game consoles, tablet PC, touchscreen, stylus, or text, devices that attached to a telephone or other data line permanently in the home of the care recipient, dedicated to the inputting and transmission of health care data collected.

The system and method of the present invention can provide connections between itself and third party systems, including but not limited to: government agencies, Medicaid and Medicare, insurance companies and third party payers, physicians, registered nurses, pharmacists, geriatric care managers, consultants, and/or financial or social custodians.

The present invention can also be integrated with web cams, various sensing devices, fall prevention systems, and emergency notification systems.

The present invention can also be integrated with medical classification, procedural or diagnostic codes and databases, including but not limited to: Diagnostic Related Groups (DRGs), which classify medical and surgical disease, injuries and disorders; Current Procedural Terminology (CPT) codes—procedures undertaken by physicians and other health care professionals to validate and treat specific diagnostic findings; International Classification of Diseases and Related Health Problems (ICD)—codes to classify diseases, and a wide variety of signs, symptoms, abnormal findings, complaints, social circumstances and external causes of injury or disease. Every health condition is assigned to a unique category and given a code

The present invention can also be interfaced with any existing databases such as, but not limited to, diagnostic, drug interactions, indications and counter indications, glossaries and service directories.

The present invention is applicable to any health setting, including but not limited to: pediatric, child care, education, chronic diseases, including muscular dystrophy, multiple sclerosis, diabetes, and/or physical therapy.

The present invention can provide care comparison data, to assess qualitative and quantitative impacts, costs and benefits, and implications of different care, treatment, medication and other modalities.

### Illustrative Operating Environment

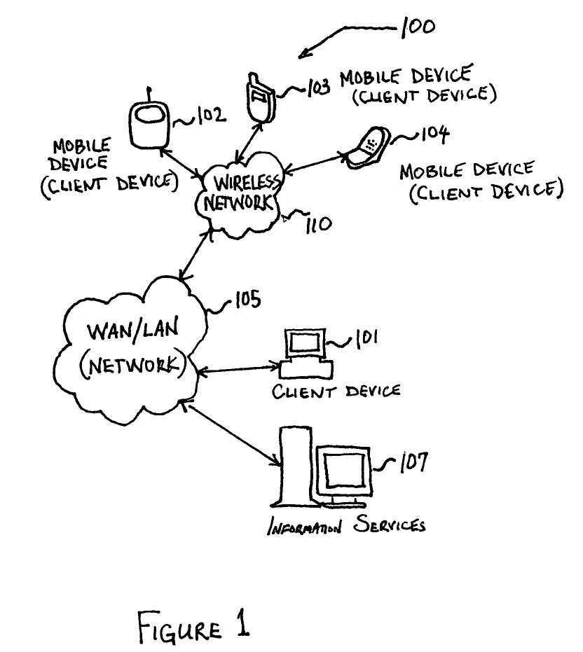

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, mobile devices (client devices) 102-104, client device 101, and information services 107.

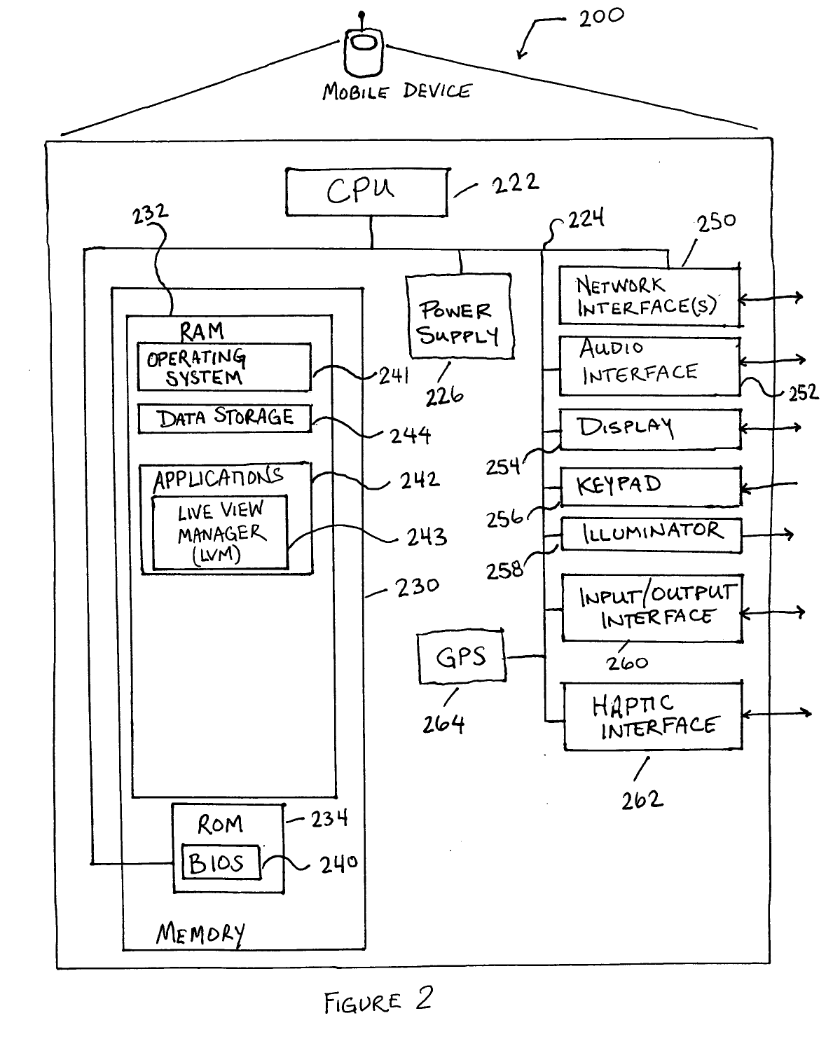

One embodiment of mobile devices 102-103 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A Web-enabled mobile device may include a Web browser or Web viewing application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent client device 101, or other computing devices.

Mobile devices 102-104 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as a client device 101, or the like. However, the present invention is not limited to these message protocols, and virtually any other message protocol may be employed.

Mobile devices 102-104 may be further configured to enable a user or users to participate in communications sessions, such as IM sessions. As such, mobile devices 102-104 may include a client application that is configured to manage various actions on behalf of the client device. For example, the client application may enable a user to interact with the browser application, email application, IM applications, SMS application, and the like.

Mobile devices 102-104 may further be configured to include a client application that enables the end-user to log into an end-user account that may be managed by another computing device. Such end-user account, for example, may be configured to enable the end-user to receive emails, send/receive IM messages, SMS messages, access selected web pages, or the like. However, logging into the end-user account may not be necessary.

Mobile devices 102-104 may also communicate with non-mobile client devices, such as client device 101, or the like. In one embodiment, such communications may include sending/receiving of messages.

Client device 101 may include virtually any computing device capable of communicating over a network to send and receive information. The set of such devices may include devices that typically connect using a wired or wireless communications medium such as personal computers, tablet and laptop computers, multiprocessor systems, microprocessor-based or programmable consumer electronics, network PCs, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple Data Storage Services (not shown) and its components with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between Data Storage Services, client device 101, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Information services 107 represents a variety of service devices that may provide additional information for use in generating patient plans of care, treatment modalities, activity suggestions, training, indications and behaviors prompting alerts, drug and alternative therapy information and counter indications, diet, exercise and meals, and other pertinent information. Such services include, but are not limited to web services, third-party services, audio services, video services, email services, IM services, SMS services, VOIP services, calendaring services, photo services, or the like. Devices that may operate as information services 107 include personal computers desktop computers, multiprocessor systems, microprocessor-based or programmable consumer electronics, network PCs, servers, and the like. Information services may be a database or multiple databases in communication that store or process data captured via the interface of the present invention. For example, the interface of the present invention may be a mobile device as described herein that permanently or periodically is connected to a network from which the information services 107 is accessible.

### Illustrative Mobile Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand. The display may also be able to show pictures, video and other graphics.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth.™., or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. This system may be used in conjunction with establishing the time that home care aides are in a home, or other delivery of services to specific locations. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX.™., or a specialized client communication operating system such as Windows Mobile.™., or the Symbian.®. operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Moreover, data storage 244 may also be employed to store social and care information (or other collected data) including activities, location (such as inside the house or outdoors or at another facility such as a senior center), or the like. At least a portion of the social and care information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth.

### Illustrative Server Environment

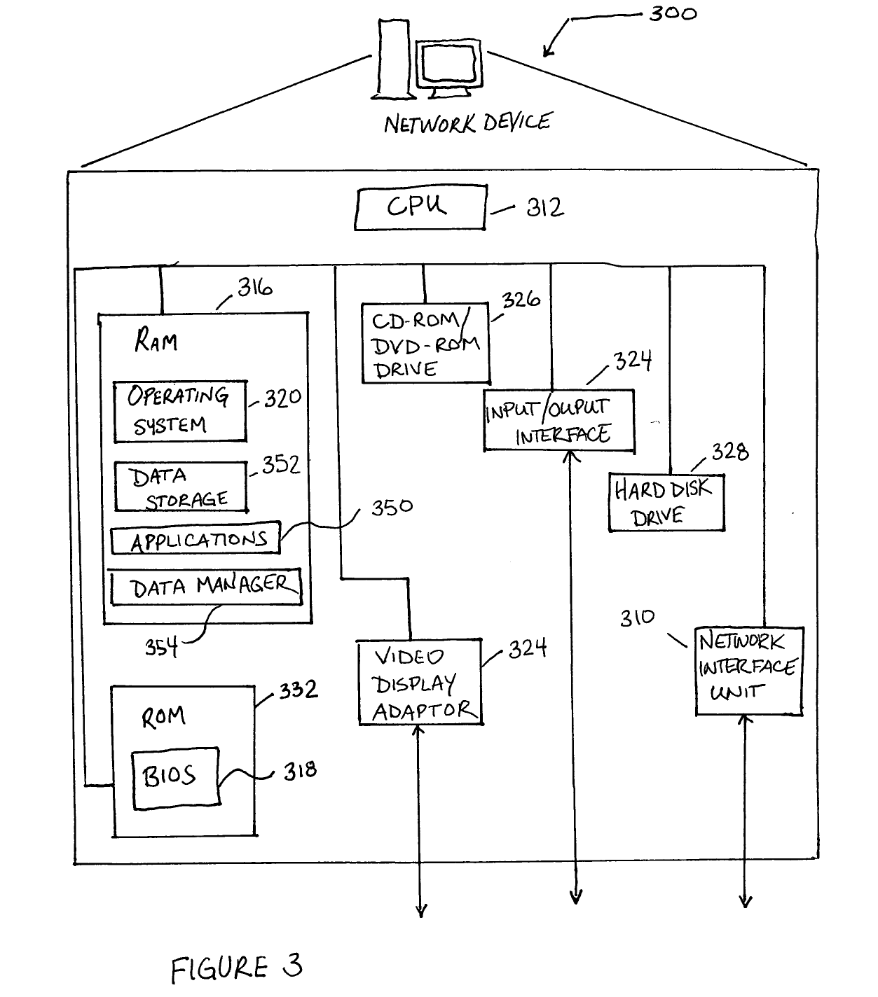

FIG. 3 shows one embodiment of a network device, according to one embodiment of the invention. Network device 300 may include many more components than those shown. The components shown, however, are sufficient to disclose an illustrative embodiment for practicing the invention.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth.

The Data Manager 354 is configured to receive from a variety of sources information that may be associated with patient-related care activities. Such information may include but is not limited to various communications, including emails, SMS messages, IM messages, audio messages, VOIP messages, RSS feeds, membership information, calendar events, photo streams, web pages, or the like.

### Illustrative Interface

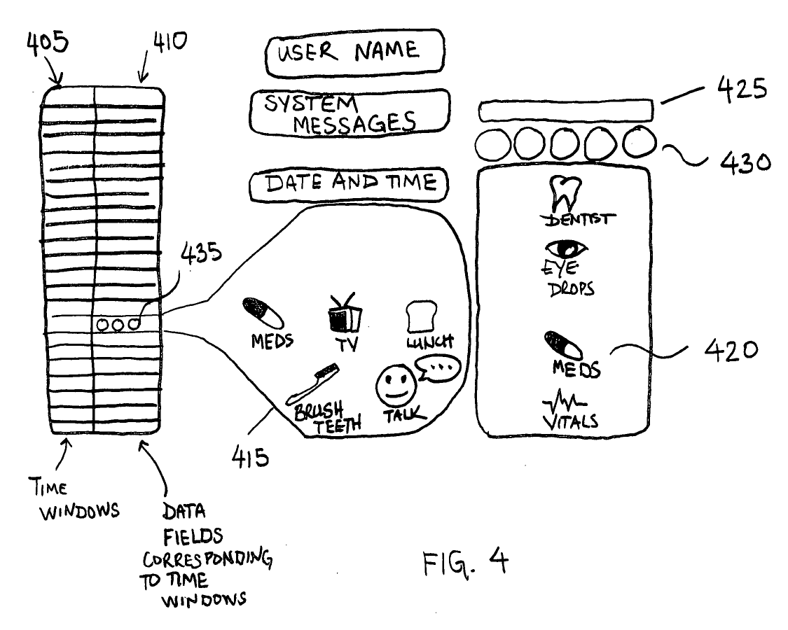

Next is described an embodiment of a possible interface that is directed to illustrating how an interface consistent with the present invention operates. It should be noted however, that the presented interface is intended as an example only and is not intended to limit or otherwise restrict the invention or its uses. Thus, for example, FIG. 4 illustrates a schematic representation of a logger window (i.e., any interface capable of receiving and/or logging data) in accordance with the present invention and is annotate to better describe its features.

A portion of a day is broken down into discrete time segments 405 wherein each times segment 410 represents a data field. Each data field may have a color associated with it to further characterize the data associated with the particular data field. Selecting any one data field produces a palette 415 (i.e., any designated area in the interface for receiving pictographs). The palette 415 provides work area in which to collect pictographs that are representational of the data collected and to be associated with the particular data field. In this particular illustration, pictographs for PRN medication, watched TV, brushed teeth, talkative and ate lunch have been placed in the palette 415. Selectable pictographs are shown at 420. Related classes of pictographs can be grouped together to permit related sets of pictographs to be presented to a user. In this illustration the pictographs associated with medical concepts is shown. Additionally, classes of pictographs are shown at 425 and in this illustration include the class of pictographs related to mood, food, hygiene, and activities 430. Moreover, each pictograph is assigned a color that relates it to a particular class. The assigned color carries over to the data field so that a user of the system may not be able to discern the particular pictograph selected without expanding out the data field but can tell the types of observables from the color of the individual circles 435 and the number of observables from the number of circles 435 in each data field. The color assigned to each pictograph and assigned to each data field provides a significant amount of qualitative information at a glance.

### Illustrative Use Cases

Next are described embodiments of possible use cases that are directed towards illustrating how select embodiments of the present invention operate. It should be noted however, that presented user cases are intended as examples only and are not intended to limit or otherwise restrict the invention or its uses.

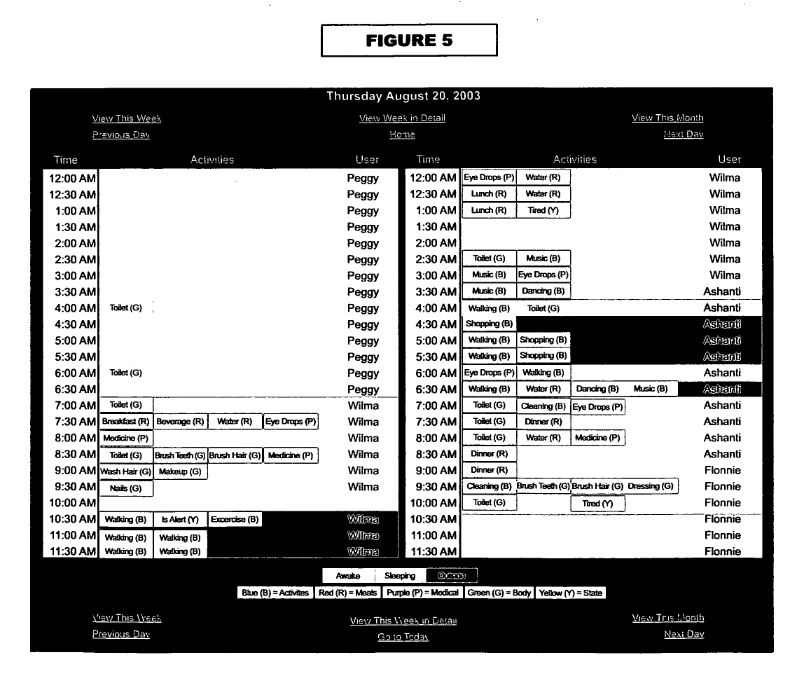

FIG. 5 illustrates a journal page for a 24 hour time period. The journal page illustrates the association of a user with entries made by the user. The individual entries result from dragging pictographs to the palette for the relevant data field. The entries carry forward the color code schemes from the logger window.

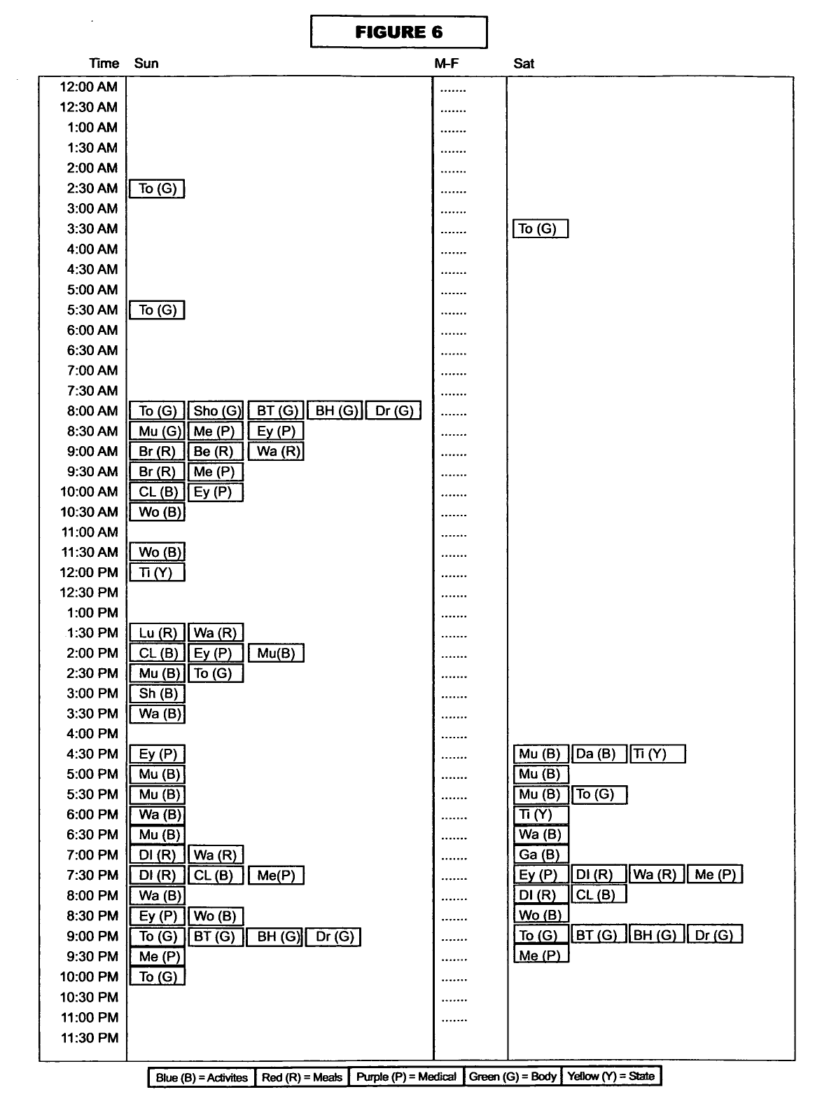

FIG. 6 illustrates a journal page for an entire week time period. The individual entries result from dragging pictographs to the palette for the relevant data field. The entries carry forward the color code schemes from the logger window. Shown here, each pictograph entered into a data field has been translated and abbreviated in Romanized letters to provide more detail as to what specific observables and data was recorded.

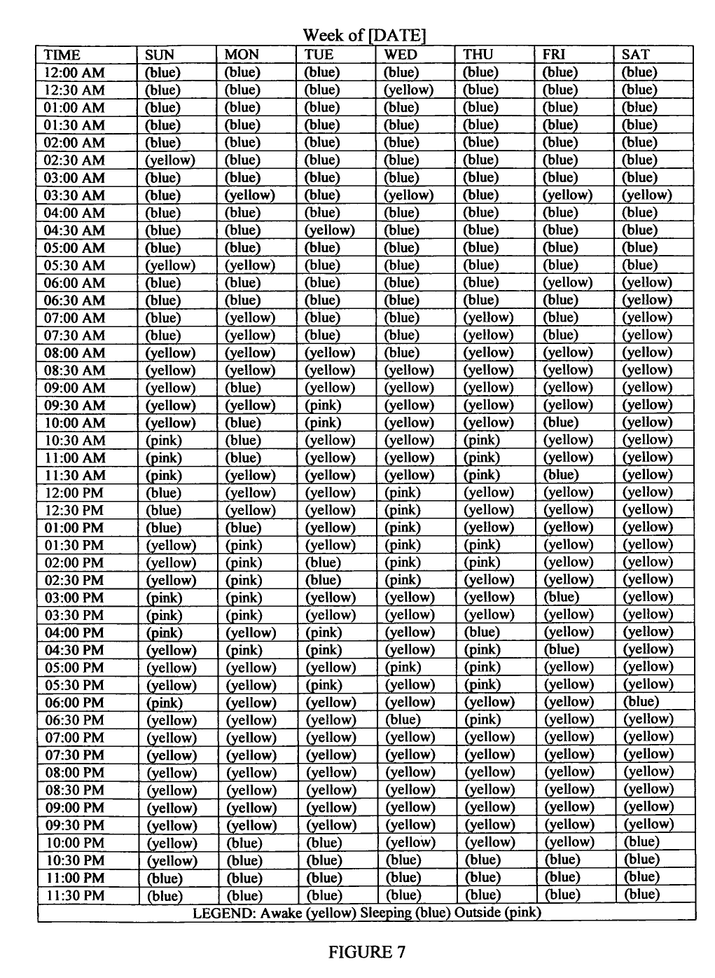

FIG. 7 illustrates a journal page for an entire week time period. The individual entries result from dragging pictographs to the palette for the relevant data field. The entries carry forward the color code schemes from the logger window. No annotations are provided with the entries. The color associated with each entry is the result of the colors assigned to each data field and not the individual pictographs.

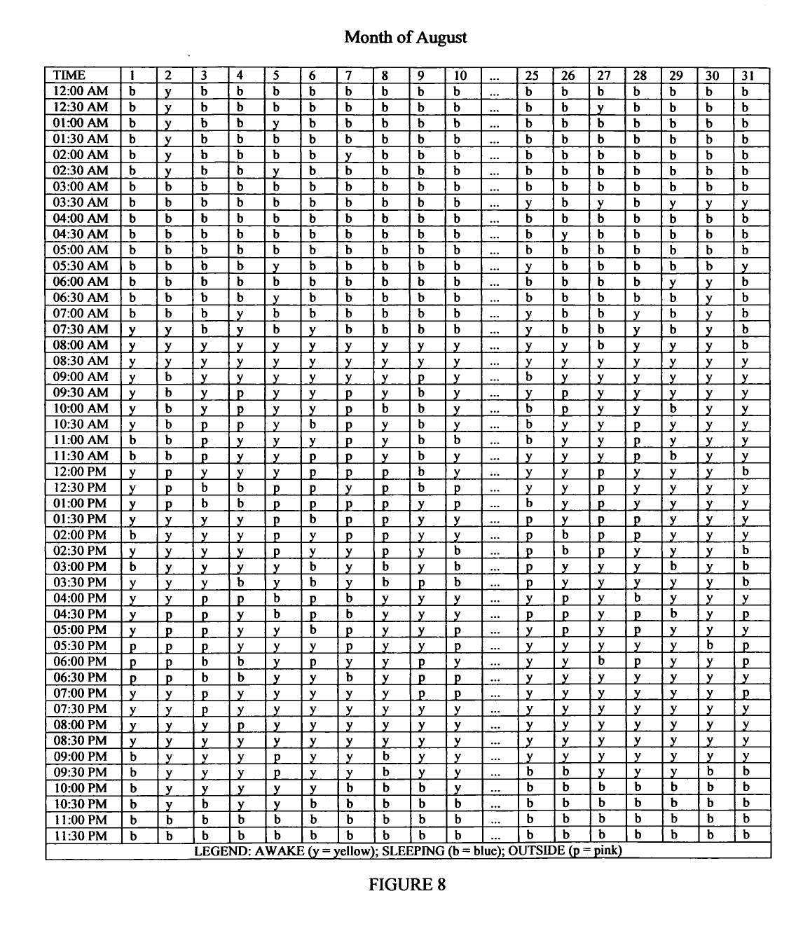

FIG. 8 illustrates a journal page for an entire month time period. The individual entries result from dragging pictographs to the palette for the relevant data field. The entries carry forward the color code schemes from the logger window. No annotations are provided with the entries. The color associated with each entry is the result of the colors assigned to each data field and not the individual pictographs.

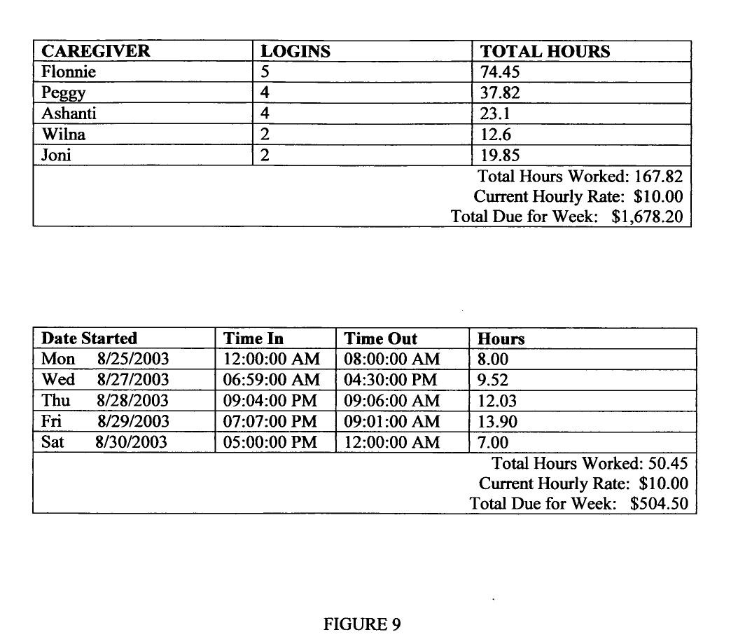

FIG. 9 illustrates a summary report showing the total time each caregiver provided care as determined by the number of data fields populated by the particular caregiver times the time interval of each data field. This information can then be used to calculate payroll. This report is a simple extension of the present invention. Thus by populating data fields the system is able to determine the number of hours worked by each caregiver by associating a unique user identification code with each user and with the pictographs entered by each user.

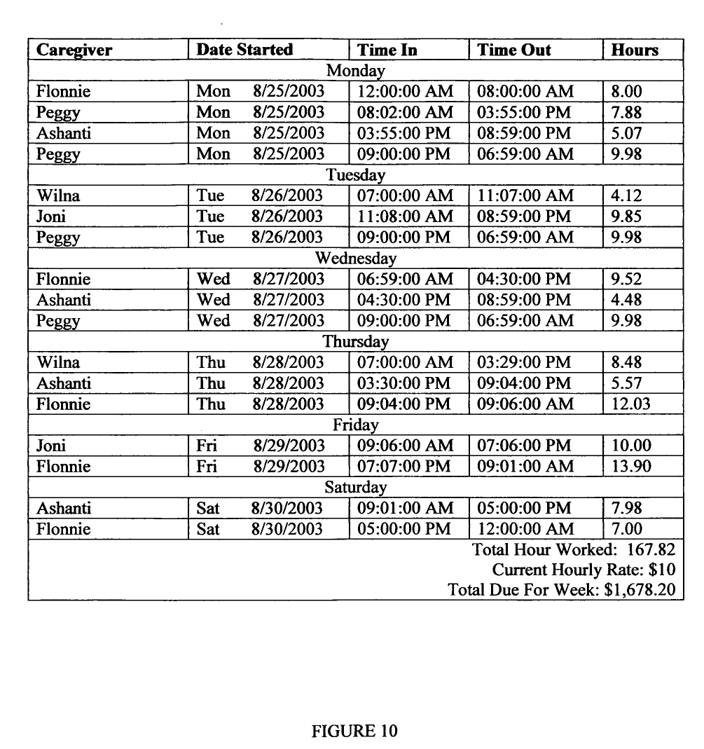

FIG. 10 illustrates a report produced by the present invention that shows the number of hours each caregiver worked Monday through Saturday for a particular week. This report is a simple extension of the present invention. Thus by populating data fields with pictographs the system is able to determine the number of hours worked by each caregiver by associating a unique user identification code with each user and with the pictographs entered by each user.

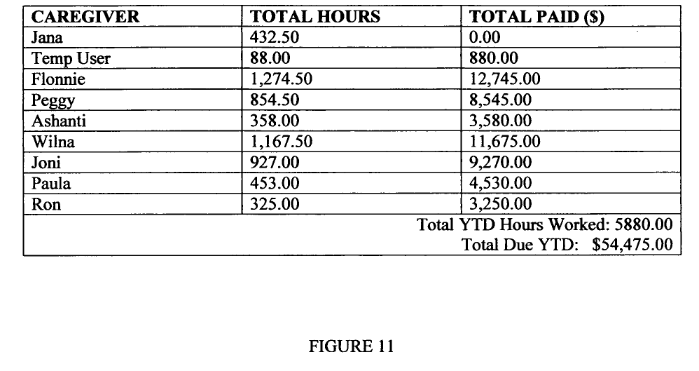

FIG. 11 illustrate a report produced by the present invention that shows the total hours worked and amount paid to each caregiver for a particular year. This report is a simple extension of the present invention. Thus by populating data fields with pictographs the system is able to determine the number of hours worked by each caregiver by associating a unique user identification code with each user and with the pictographs entered by each user.

### CONCLUSION

Although the above description contains many specificities, these should not be construed as limitation on the scope of the invention but merely as illustration of some of the presently preferred embodiments. Many other embodiments of the invention are possible. It will be apparent to one skilled in the art that many other system architectures, programming languages, devices, input methods and output formats may be used to implement the invention. Thus, it is intended that the present invention covers modifications and variations of this invention provided they come within the scope of the appended claims and their equivalents.

Moreover, the invention is not limited to the specific applications described. The system and method of the invention have may other applications both inside and outside of the healthcare industry. For example, the pictographs presented to a user may be configured to represent primary care or classroom activities and tasks, so that educators and parents are able to monitor children's activities in educational facilities, and interact with the selection and fulfillment of such activities.

Further, the invention has numerous applications for gathering data from remotely located devices. For example, the system may be used to interface with smart appliances and/or other dedicated devices for collecting data from same.

The embodiments of the invention in which an exclusive property or privilege is claimed are defined as follows:

1. A method receiving information, said method comprising:
displaying a selectable pictograph from a at least one of a configurable group or groups of pictographs, a predetermined set of pictographs, or combination thereof;
receiving instructions to assign the selectable pictograph to a data field; and
updating a database with the information represented by the selectable pictograph.

2. The method of claim 1, wherein the information represented by the selectable pictograph comprises at least one of an observed health state, an observed condition of an individual, an observed state of an individual, an observed characteristic of an individual during at least one of a course of treatment, a period of medical care or combination thereof.

3. The method of claim 1, further comprising displaying a palette for receiving pictographs, said palette associated with at least one data field, wherein said data field represents a predefined time interval.

4. The method of claim 3, wherein the instructions to assign the selected pictograph to a data field are received when a user does one of drags and drops the selectable pictograph to the palette or data field, selecting the selectable pictograph by touching the pictograph on a touchscreen, or combination thereof.

5. The method of claim 4, wherein the members of each of said set of pictographs has a color assigned to it, wherein each color represents the class of which each pictograph is a member.

6. The method of claim 4, further comprising assigning a user identification code to each pictograph selected by the user, wherein each user identification code is unique to the user.

7. The method of claim 6, further comprising calculating the dollar amount to pay each user from the data fields populated.

8. The method of claim 1, further comprising updating the database with the information represented by the selectable pictograph only if the selectable pictograph is compatible with the data field and/or other selectable pictographs selected for entry into the data field.

9. The method of claim 1, further comprising displaying a course of medical care through a set of selectable pictographs.

10. The method of claim 9, wherein said set of selectable pictographs are revised based on collected data.

11. The method of claim 1, wherein the selectable pictograph represents at least one of a concept, object, activity, place, event, task, state of being, condition, task, medical information, report data, environmental conditions, function, body task, schedule, or combination thereof.

12. The method of claim 1, further comprising comparing the information used to update the database against one of a plan of care, insurance requirements, physician instructions, nurse instructions, compliance rules and regulations or combinations thereof.

13. The method of claim 1, further comprising sending pictograph instructions to a user instructing the user to perform a task.

14. The method of claim 1, wherein each pictograph from said configurable group or groups of pictographs, a predetermined set of pictographs, or combination thereof has at least one of text, sound or combination thereof associated with it.

15. The method of claim 1, further comprising translating each of said selected pictograph or an attribute associated with each of said selected pictograph into at least one graph, chart, or combination thereof.

16. The method of claim 1, further comprising displaying a grouping of selectable pictographs representing personal preferences of an individual.

17. The method of claim 1, further comprising employing said method in the health services industry.

18. A method of recording information in a database, the method comprising:
providing a graphical user interface;
providing a browseable catalog of selectable pictographs within said graphical user interface;
providing at least one data field for at least one of receiving, assigning, associating or combination thereof at least one selectable pictograph;
receiving instructions to assign at least one selectable pictograph to at least one data field or palette associated with one data field; and
storing the information contained in at least one selectable pictograph in a database.

19. A system for recording information, the system comprising:
a client computing device, a server computing device, a network link between said client computing device and said server computing device;
a graphical user interface operable on said client computing device;
a catalog of selectable pictographs generated by said server computing device and displayable in said graphical user interface;
a collection of data fields generated by said server computing device and displayable in said graphical user interface; and
a processor that is operable to perform actions, including, assigning selectable pictographs selected from said catalog of selectable pictographs to at least one data field and directing the storage of the information contained in each selected selectable pictograph to a computer readable medium.

20. The system according to claim 19, wherein said client computing device is a mobile device or other wireless device.
